(19) United States
(12) Patent Application Publication
(10) Pub. No.: US 2014/0092058 A1
(43) Pub. Date: Apr. 3, 2014

(54) ELECTRONIC DEVICE AND WIRELESS TOUCH PANEL APPLIED THERETO

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: WEI-GUO XIAO, Shenzhen (CN); YIN ZHANG, Shenzhen (CN); YI-YING CHEN, New Taipei (TW); CHIU-HSIUNG LIN, New Taipei (TW)

(21) Appl. No.: 13/927,890

(22) Filed: Jun. 26, 2013

(30) Foreign Application Priority Data
Sep. 29, 2012 (CN) 2012103713444

(51) Int. Cl. G06F 3/046

(52) U.S. Cl. CPC G06F 3/046
USPC 345/174

(57) ABSTRACT

An electronic device includes a main body and at least one wireless touch panel. Each wireless touch panel includes a touch-sensitive module, a processing module, a wireless energy receiving module, and a first wireless communication module. The wireless energy receiving module receives electromagnetic energy from the main body and converts the received electromagnetic energy into electric energy to power other function modules of the wireless touch panel. The touch-sensitive module produces touch signals in response to a user's touch operations, and the first wireless communication module sends the touch signals to the main body to activate corresponding functions of the electronic device. The first wireless communication module also receives wireless control signals from the main body, and the processing module activates functions of the wireless touch panel in response to the wireless control signals.

### BACKGROUND

1. Technical Field

The present disclosure relates to an electronic device and a wireless touch panel applied to the electronic device.

2. Description of Related Art

With the popularization of electronic devices with touch-sensitive functions, such as tablet computers and electronic readers, lightening and thinning of the electronic devices are among the important aspects in manufacturing them. Usually, a flexible printed circuit board is used to connect a touch panel to a main body of the electronic device. However, the space occupied by the flexible printed circuit board is an obstacle in satisfying the light and thin requirements of the electronic devices.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a wireless touch panel, according to an embodiment.

FIG. 2 is a schematic view of an electronic device, including a main body and the wireless touch panel of FIG. 1.

### DETAILED DESCRIPTION

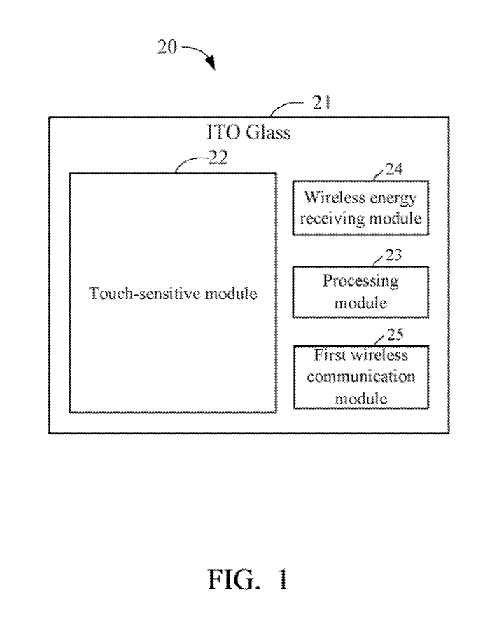

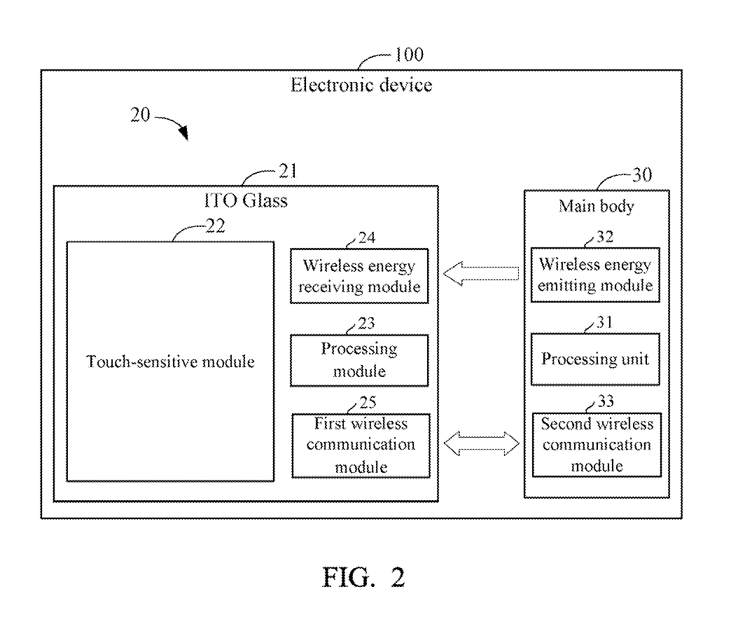

Referring to FIGS. 1-2, a wireless touch panel 20 is able to communicate with a main body 20 of an electronic device 100 through wireless communication technologies. The wireless touch panel 20 can be a resistive touch panel, a capacitive touch panel, or an electromagnetic touch panel. The wireless touch panel 20 includes an Indium Tin Oxide (ITO) Glass 21, a touch-sensitive module 22, a processing module 23, a wireless energy receiving module 24, and a first wireless communication module 25. In the embodiment, the touch-sensitive module 22, the processing module 23, the wireless energy receiving module 24, and the first wireless communication module 25 are mounted onto the ITO Glass 21.

The wireless energy receiving module 24 receives electromagnetic energy having a specific frequency from the main body 30 and converts the received electromagnetic energy into electric energy to power the touch-sensitive module 22, the processing module 23, the wireless energy receiving module 24, and the first wireless communication module 25.

The touch-sensitive module 22 produces touch signals in response to a user's touch operations.

The processing module 23 converts the touch signals produced by the touch-sensitive module 22 into wireless touch signals.

The first wireless communication module 25 encodes the wireless touch signals and sends the encoded wireless touch signals to the main body 30. The first wireless communication module 25 further receives and decodes wireless control signals sent from the main body 30 and sends the decoded wireless control signals to the processing module 23.

The processing module 23 further activates functions of the wireless touch panel 20 in response to the decoded wireless control signals, such that the wireless touch panel 20 can communicate and interact with the main body 30 of the electronic device 100.

Referring to FIG. 2, the electronic device 100 employs the wireless touch panel 20 and the main body 30 as illustrated. The main body 30 includes a processing unit 31, a wireless energy emitting module 32, and a second wireless communication module 33.

The wireless energy emitting module 32 emits electromagnetic energy having a specific frequency to the wireless energy receiving module 24 of the wireless touch panel 20.

The second wireless communication module 33 receives and decodes the wireless touch signals sent from the first wireless communication module 25 and sends the decoded wireless touch signals to the processing unit 31.

The processing unit 31 activates functions of the electronic device 100 in response to the decoded wireless touch signals, such as controlling a display screen (not shown) to display a corresponding interface. The processing unit 31 further produces wireless control signals to control the wireless touch panel 20 to execute corresponding functions, such as if the touch-sensitive module 22 detects no touch operation for a predetermined time period, the processing unit 31 produces a wireless control signal to lock the wireless touch panel 20.

The second wireless communication module 33 further receives and encodes the wireless control signals produced by the processing unit 31 and sends the encoded wireless control signals to the first wireless communication module 25.

Depending on the embodiment, the first wireless communication module 25 and the second wireless communication module 33 can be an infrared module, a Bluetooth module, a Z-wave module, or a ZigBee module, such that the wireless touch panel 20 communicates with the main body 30 through infrared, Bluetooth, Z-wave, or ZigBee technologies.

In another embodiment, the electronic device 100 includes multiple wireless touch panels 20, and the wireless energy emitting module 32 of the main body 30 emits electromagnetic energy having different specific frequencies to the wireless energy receiving modules 24 of the different wireless touch panels 20 correspondingly. The second communication module 33 communicates with the first communication modules 25 of the wireless touch panels 20 in different encoding and decoding ways, such that the main body 30 can communicate with each wireless touch panel 20 point-to-point.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A wireless touch panel comprising:
a touch-sensitive module configured to produce touch signals in response to a user's touch operations;
a processing module configured to convert the touch signals into wireless touch signals; and
a first wireless communication module configured to encode the wireless touch signals and send the encoded wireless touch signals to a main body of an electronic device; the first wireless communication module further configured to receive and decode wireless control signals sent from the main body; the processing module further configured to activate functions of the wireless touch panel in response to the decoded wireless control signals; and
a wireless energy receiving module configured to receive electromagnetic energy having a specific frequency from the main body of the electronic device, and convert the received electromagnetic energy into electric energy to power the touch-sensitive module, the processing module, the wireless energy receiving module and the first wireless communication module.

2. The wireless touch panel as described in claim 1, further comprising an ITO Glass, wherein the touch-sensitive module, the processing module, the wireless energy receiving module and the first wireless communication module are mounted on the ITO Glass.

3. The wireless touch panel as described in claim 2, wherein the first wireless communication module is selected from a group consisting of an infrared module, a Bluetooth module, a Zwave module, and a Zigbee module.

4. An electronic device comprising:
a main body; and
at least one wireless touch panel, each wireless touch panel comprising:
a touch-sensitive module configured to produce touch signals in response to a user's touch operations;
a processing module configured to convert the touch signals into wireless touch signals; and
a first wireless communication module configured to encode the wireless touch signals and send the encoded wireless touch signals to the main body; the first wireless communication module further configured to receive and decode wireless control signals sent from the main body; the processing module further configured to activate functions of the wireless touch panel in response to the decoded wireless control signals; and
a wireless energy receiving module configured to receive electromagnetic energy having a specific frequency from the main body of the electronic device, and convert the received electromagnetic energy into electric energy to power the touch-sensitive module, the processing module, the wireless energy receiving module and the first wireless communication module.

5. The electronic device as described in claim 4, wherein the main body comprises:
a wireless energy emitting module configured to emit electromagnetic energy having a specific frequency to the wireless energy receiving module of the wireless touch panel;
a second wireless communication module configured to receive and decode the wireless touch signals sent from the first wireless communication module;
a processing unit configured to activate functions of electronic device in response to the decoded wireless touch signals; the processing unit further configured to produce wireless control signals to control the wireless touch panel to execute corresponding functions; and
the second wireless communication module further configured to receive and encode the wireless control signals produced by the processing unit, and send the encoded wireless control signals to the first wireless communication module.

6. The electronic device as described in claim 4, further comprising an ITO Glass, wherein the touch-sensitive module, the processing module, the wireless energy receiving module and the first wireless communication module are mounted on the ITO Glass.

7. The electronic device as described in claim 4, wherein both of the first wireless communication module and the second communication module are selected from a group consisting of an infrared module, a Bluetooth module, a Z-wave module, and a ZigBee module.

8. The electronic device as described in claim 4, wherein the at least one of the wireless touch panels includes a plurality of wireless touch panels, and the main body comprises a wireless energy emitting module, the wireless energy emitting module is configured to emit electromagnetic energy having different specific frequencies to the wireless energy receiving modules of the corresponding wireless touch panels.
